(19) United States
(12) Patent Application Publication
(10) Pub. No.: US 2026/0320975 A1
(43) Pub. Date: Oct. 15, 2026

(54) APPARATUS AND METHOD FOR IMAGE PROCESSING USING CHANNEL-GROUPED SELECTIVE SCANNING

(71) Applicant: MEDIATEK INC., Hsinchu City (TW)

(72) Inventors: Yu-Syuan Xu, Hsinchu City (TW); Yu-Cheng Lin, Hsinchu City (TW)

(73) Assignee: MEDIATEK INC., Hsinchu City (TW)

(21) Appl. No.: 19/635,758

(22) Filed: Mar. 31, 2026

Related U.S. Application Data
(60) Provisional application No. 63/788,133, filed on Apr. 14, 2025.

(51) Int. Cl. G06V 10/77

(52) U.S. Cl. CPC G06V 10/7715

(57) ABSTRACT

An apparatus and method for processing an image are disclosed. The method comprises partitioning a first feature map, derived from an input feature map having a plurality of channels, into a plurality of channel groups along a channel dimension. For each of the plurality of channel groups, the channel group is transformed from a two-dimensional (2D) format into a one-dimensional (1D) sequence based on a predetermined scanning pattern. A selective scan operation is performed on the 1D sequence to model long-range dependencies, generating a corresponding 1D output sequence. An inverse transformation is then performed on the 1D output sequence to generate a corresponding 2D output group. The 2D output groups are concatenated along the channel dimension to form a second feature map. A final output feature map is subsequently generated based on the second feature map.

### CROSS REFERENCE TO RELATED APPLICATIONS

This application claims the benefit of U.S. Provisional Application No. 63/788,133, filed on Apr. 14, 2025. The content of the application is incorporated herein by reference.

### BACKGROUND

Image restoration is a fundamental task in modern image processing, with applications such as super-resolution, denoising, and deblurring. To generate high-quality images from low-quality inputs, deep learning models must effectively understand both the content and structure of an image. Traditionally, Convolutional Neural Networks (CNNs) have been used for this purpose. CNNs are effective at extracting local features, such as textures and edges, but often struggle to capture global information that spans the entire image.

To address this limitation, Transformer-based models were introduced to image processing. Transformers can process an entire image to capture global dependencies among all pixels. However, this capability comes at a significant computational cost. The complexity of Transformer models scales quadratically with the number of pixels, meaning the required computation grows in proportion to the square of the image's resolution. This makes it challenging to apply Transformers efficiently to high-resolution image restoration tasks.

More recently, State Space Models (SSMs), such as Mamba, have emerged as a promising alternative. These models can model long-range dependencies with linear complexity, where the computational cost grows in direct proportion to the number of pixels rather than quadratically. To adapt these models for two-dimensional (2D) image data, existing methods typically convert the 2D feature map into a plurality of one-dimensional (1D) sequences using a 2D selective scan process. This involves flattening the features along predefined directions, such as horizontal and vertical scans, and processing each sequence independently.

However, this approach presents a significant drawback. To achieve a more comprehensive understanding of the image, the model should ideally process information from numerous scanning directions. Under the current paradigm, each additional scanning direction requires a separate processing path, causing the computational cost and model parameters to scale linearly with the number of scanning directions. This linear scaling limits the model's efficiency and architectural flexibility. Therefore, a need exists for a vision model architecture that can efficiently aggregate information from a plurality of scanning directions without a corresponding linear increase in computational cost.

### SUMMARY

An embodiment of the present invention provides an apparatus for processing an image. The apparatus comprises a memory for storing instructions and a processing circuit communicatively coupled to the memory. The processing circuit is configured to execute the instructions to perform operations comprising: receiving an input feature map having a plurality of channels, wherein the input feature map is derived from the image; generating a first feature map based on the input feature map; partitioning the first feature map into a plurality of channel groups along a channel dimension; and for each of the plurality of channel groups, transforming the channel group from a two-dimensional format into a one-dimensional sequence based on a predetermined scanning pattern, performing a selective scan operation on the one-dimensional sequence to generate a corresponding one-dimensional output sequence, and performing an inverse transformation on the one-dimensional output sequence to generate a corresponding two-dimensional output group. The operations further comprise concatenating the two-dimensional output groups corresponding to the plurality of channel groups along the channel dimension to form a second feature map, and generating a final output feature map based on the second feature map.

Another embodiment of the present invention provides a method for processing an image. The method, performed by a processing circuit executing instructions stored in a memory, comprises: receiving an input feature map having a plurality of channels, wherein the input feature map is derived from the image; generating a first feature map based on the input feature map; partitioning the first feature map into a plurality of channel groups along a channel dimension; and for each of the plurality of channel groups, transforming the channel group from a two-dimensional format into a one-dimensional sequence based on a predetermined scanning pattern, performing a selective scan operation on the one-dimensional sequence to generate a corresponding one-dimensional output sequence, and performing an inverse transformation on the one-dimensional output sequence to generate a corresponding two-dimensional output group. The method further comprises concatenating the two-dimensional output groups corresponding to the plurality of channel groups along the channel dimension to form a second feature map, and generating a final output feature map based on the second feature map.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating an image processing apparatus, in accordance with an embodiment of the disclosure.

FIG. 2 is a schematic diagram illustrating a processing pipeline of the image processing apparatus of FIG. 1, in accordance with an embodiment of the disclosure.

FIG. 3 is a detailed block diagram illustrating a MambaFormer block of the processing pipeline of FIG. 2, in accordance with an embodiment of the disclosure.

FIG. 4 is a detailed block diagram illustrating a Multi-Head Selective Scan Module (MHSSM) of the MambaFormer block of FIG. 3, in accordance with an embodiment of the disclosure.

FIG. 5 is a schematic diagram illustrating an operational flow of a Multi-Head Selective Scan (MHSS) operation within the MHSSM of FIG. 4, in accordance with an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

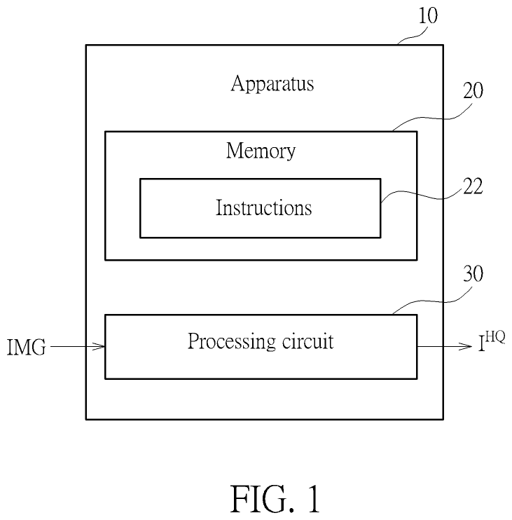

FIG. 1 is a functional block diagram illustrating an apparatus 10, in accordance with an embodiment of the disclosure. The apparatus 10 is configured to receive an input image IMG and to generate a final output feature map I^{HQ}. The final output feature map I^{HQ} may be, for example, a high-quality, restored, or enhanced version of the input image IMG. The apparatus 10 comprises a memory 20 and a processing circuit 30.

The processing circuit 30 is communicatively coupled to the memory 20. The processing circuit 30 is configured to receive the input image IMG, or an input feature map derived therefrom, and execute a set of instructions 22 stored in the memory 20 to perform a series of image processing operations. Upon execution of the instructions 22, the processing circuit 30 generates the final output feature map I^{HQ}.

The memory 20 stores the instructions 22, which, when executed by the processing circuit 30, configure the apparatus 10 to perform the methods described herein. The memory 20 can be any suitable type of non-transitory computer-readable storage medium, such as, but not limited to, Random Access Memory (RAM), Read-Only Memory (ROM), flash memory, or a hard disk drive. The memory 20 may also store intermediate data, such as feature maps, model parameters, and other data generated during the image restoration process.

In various embodiments, the processing circuit 30 may be implemented as one or more processors, such as a Central Processing Unit (CPU), a Graphics Processing Unit (GPU), a Digital Signal Processor (DSP), an Application-Specific Integrated Circuit (ASIC), a Field-Programmable Gate Array (FPGA), a Neural Processing Unit (NPU), or any combination of these processing components suitable for performing complex computational tasks related to image processing and machine learning.

The apparatus 10 may be embodied in various physical forms. For example, the apparatus 10 can be implemented within a single integrated circuit, such as a System-on-a-Chip (SoC), where the processing circuit 30 and the memory 20 are integrated onto a single semiconductor die. This configuration is suitable for devices where physical space and power efficiency are important issues, such as mobile phones, smart cameras, tablet computers, drones, and other embedded systems.

In other embodiments, the apparatus 10 may be implemented as part of a larger computing system. For instance, the apparatus 10 could be a personal computer, a workstation, or a cloud-based server. In these configurations, the processing circuit 30 and the memory 20 are often implemented as discrete components communicatively coupled via a motherboard. The processing circuit 30 might be a standalone graphics processing unit (GPU) card, while the memory 20 could correspond to the system's main RAM.

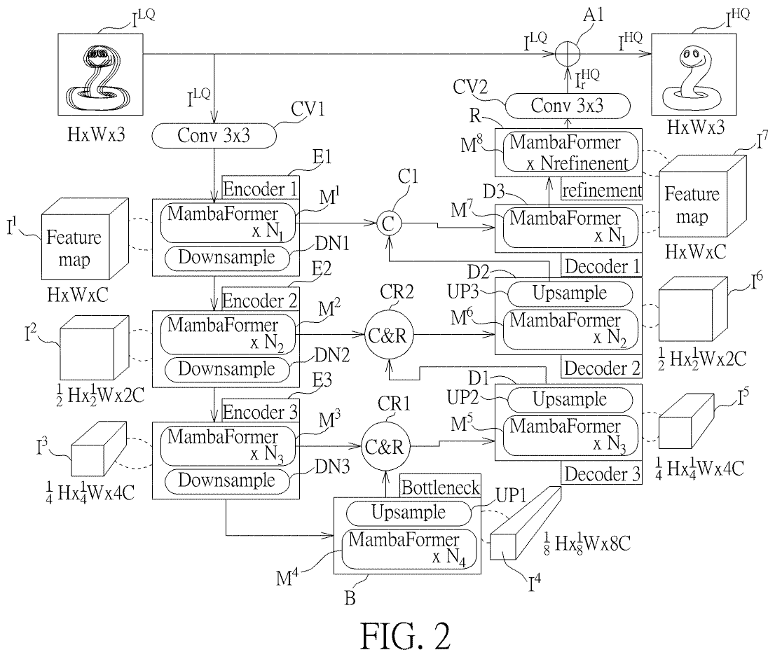

The instructions 22 configure the processing circuit 30 to implement an image processing method. In operation, the apparatus 10 processes an input feature map derived from the input image IMG. This method comprises partitioning the input feature map into a plurality of groups along the channel dimension. For each of these groups, the processing circuit 30 is configured to perform a sequence of operations. This sequence includes transforming the channel group from a two-dimensional format into a one-dimensional sequence based on a predetermined scanning pattern, performing a selective scan operation on the one-dimensional sequence to generate a corresponding one-dimensional output sequence, and performing an inverse transformation to convert the one-dimensional output sequence back into a corresponding two-dimensional output group. Finally, the processing circuit 30 concatenates the two-dimensional output groups along the channel dimension to form the final output feature map I^{HQ}. The detailed operational flow and the specific modules for performing these operations will be further elaborated with reference to FIG. 2 through FIG. 5.

FIG. 2 is a schematic diagram illustrating an operational flow of the apparatus 10 of FIG. 1, in accordance with an embodiment of the disclosure. The framework is architected as a U-Net-like encoder-decoder structure, a structure known for capturing contextual information at multiple scales. This architecture is configured to process an input feature map IL to generate a final output feature map I^{HQ}. The input feature map I^{LQ} and the final output feature map IHO both possess dimensions of height H, width W, and 3 channels. These 3 channels typically correspond to color information, such as the red, green, and blue (RGB) values that define each pixel in a standard digital image.

In many embodiments, the input feature map IL is derived from the input image IMG (shown in FIG. 1) via a convolutional layer. This extracts fundamental visual patterns like edges, corners, and textures from the raw pixel data, transforming the image into a feature space more suitable for the subsequent deep learning stages. The input feature map IL, representing these features, serves as the input to the main framework and is also utilized in a residual connection at the final stage.

The operational flow commences with a first convolution block CV1, which applies a 3×3 kernel to the input feature map I^{LQ} to generate a first intermediate feature map I¹. The first intermediate feature map I¹ has dimensions of H×W×C, where C is a predetermined number of channels for the main processing path.

Following this, the data flows into a hierarchical encoder path comprising three encoder stages: a first encoder stage E1, a second encoder stage E2, and a third encoder stage E3. In the first encoder stage E1, the feature map I¹ is processed by a first MambaFormer block M¹, which may be repeated N₁ times to progressively refine the features. The output is then passed to a first downsampling block DN1. This block reduces the spatial dimensions while increasing the channel depth, a process achieved through a 3×3 convolution followed by a PixelUnshuffle operation. This transforms the feature map into a second intermediate feature map I² with dimensions of (½)H×(½)W×2C. This process is repeated through the second encoder stage E2, which uses a second MambaFormer block M² (repeated N₂ times) and a second downsampling block DN2, to produce a third intermediate feature map I³ with dimensions of (¼)H×(¼)W×4C. The process continues through the third encoder stage E3, which uses a third MambaFormer block M³ (repeated N₃ times) and a third downsampling block DN3. The third downsampling block DN3 produces the encoder's final output feature map, which has dimensions of (⅛)H×(⅛)W×8C and serves as the input to a subsequent bottleneck stage B.

The deeply encoded features are then processed by a bottleneck stage B, which includes a fourth MambaFormer block M⁴ repeated N₄ times. This stage operates on the features at their smallest spatial resolution ((⅛)H×(⅛)W) and highest channel depth (8C), generating a fourth intermediate feature map I⁴ with dimensions of (⅛)H×(⅛)W×8C.

The decoder path then reconstructs the image details through a series of decoder stages: a first decoder stage D1, a second decoder stage D2, and a third decoder stage D3. These stages mirror the encoder path and employ connections to merge high-resolution features from the encoder with the upsampled features from the decoder, which helps in preserving fine details. In the first decoder stage D1, the feature map 14 is upsampled by a first upsampling block UP1. This upsampling operation is performed using a 3×3 convolution followed by a PixelShuffle operation. The upsampled feature map is then combined with the feature map output by the third MambaFormer block M³ at a first concatenation and reduction block (C&R) CR1. This block, labeled C&R, performs a channel concatenation, where the feature maps are stacked along their channel dimension, followed by a channel reduction, typically using a 1×1 convolution, to fuse the features and manage channel depth. The fused features are then processed by a fifth MambaFormer block M⁵ (repeated N₃ times) to generate a fifth intermediate feature map 15. This process of upsampling, concatenation-and-reduction, and Mamba Former processing is repeated in the second decoder stage D2. In the second decoder stage D2, the feature map 15 is processed by a second upsampling block UP2, a second C&R block CR2 that incorporates the feature map output by the second MambaFormer block M², and a sixth MambaFormer block M⁶ (repeated N₂ times) to produce a sixth intermediate feature map I⁶. The third decoder stage D3 further upsamples the features via a third upsampling block UP3, combines them with the feature map I¹ via a concatenation operation C1, and processes them with a seventh MambaFormer block M⁷ repeated N₁ times to produce a seventh intermediate feature map I⁷.

A refinement stage R follows the decoder path. Here, the feature map I⁷ from the decoder's final stage is processed by a refinement MambaFormer block M⁸ (repeated Nrefinement times) and a second 3×3 convolution block CV2, producing a residual feature map

$${I}_{r}^{HQ} .$$

Finally, at an adder A1, a residual connection is formed by performing an element-wise addition between the residual feature map

$${I}_{r}^{HQ}$$

and the original input feature map I^{LQ}. An element-wise operation is one where corresponding elements of two feature maps are operated on individually. This final addition allows the network to focus on learning the difference, or residual, between the low-quality and high-quality images, ultimately producing the final output feature map I^{HQ}, which represents the restored high-quality image data with dimensions H×W×3.

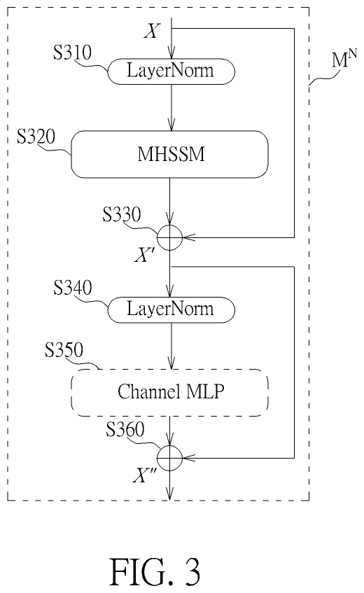

FIG. 3 is a detailed block diagram illustrating a MambaFormer block MN, which is an important component of the framework shown in FIG. 2. As previously described, this MambaFormer block MN can represent any of the MambaFormer blocks M¹ through M⁸, serving as the component for feature processing within the encoder, decoder, bottleneck, and refinement stages. The MambaFormer block MN is designed to receive an input feature map X and produce a refined output feature map X″. The architecture is inspired by standard Transformer blocks, comprising two main components: the Multi-Head Selective Scan Module (MHSSM) for token mixing and a channel Multilayer Perceptron (channel MLP) for feature refinement, each preceded by a normalization layer and followed by a residual connection.

The process within the MambaFormer block MN begins with receiving an input feature map X. This feature map X is first processed in step S310 by a Layer Normalization (LayerNorm) operation. The Layer Normalization operation normalizes the features within each channel across the spatial dimensions (height and width). This process, which applies normalization prior to the main processing module, ensures that the input to the subsequent MHSSM module has a standardized distribution, which is a technique for stabilizing the training dynamics of deep networks.

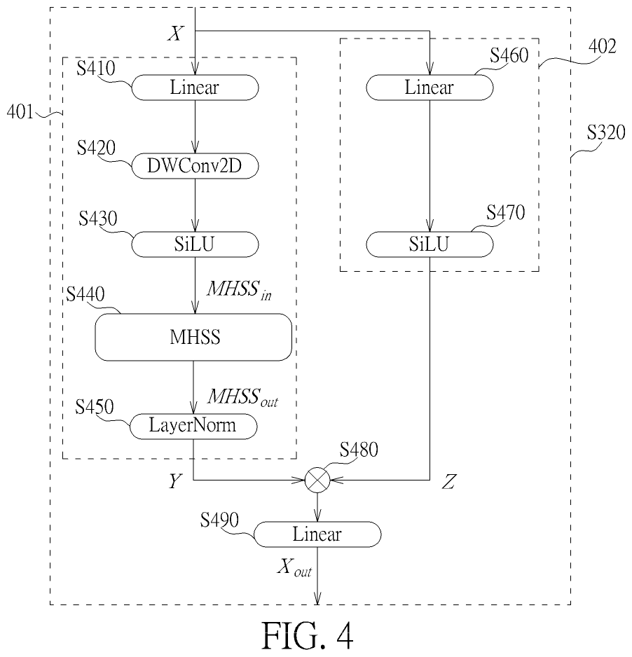

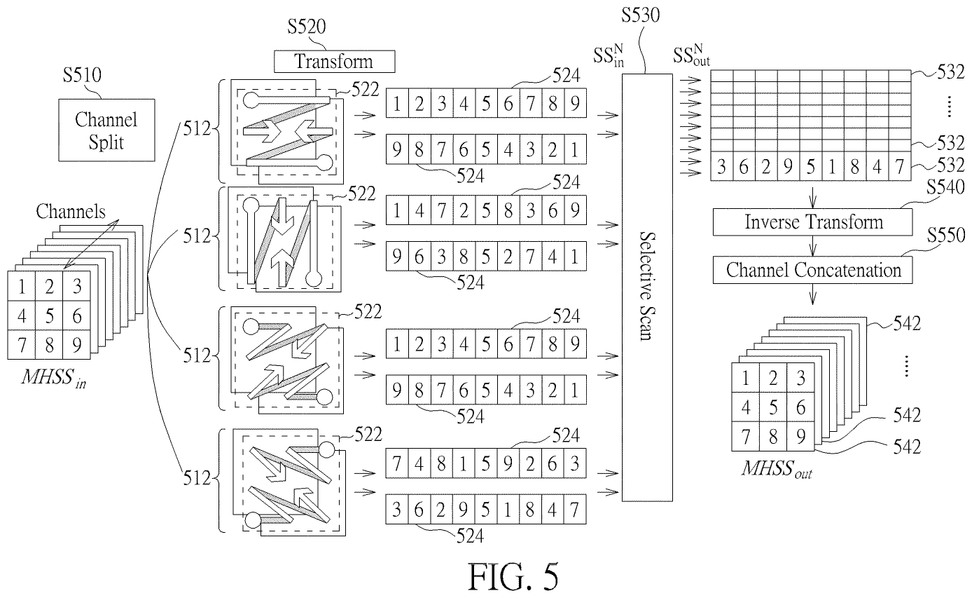

The normalized feature map then proceeds to step S320, which is a Multi-Head Selective Scan Module (MHSSM). The MHSSM is a key component responsible for “token mixing,” which is the process of aggregating spatial information across the feature map. The MHSSM effectively captures comprehensive spatial context with linear computational complexity. The detailed operational flow of the MHSSM will be further elaborated with reference to FIG. 4 and FIG. 5.

The output of the MHSSM at step S320 is then combined with the original input feature map X through an element-wise addition at step S330, forming a first residual connection. In the context of this disclosure, a residual connection is an architectural design where the output of a module (e.g., MHSSM) is added element-wise to its original input (e.g., X). This allows the module to learn a residual function, which represents the modifications to the input, rather than learning the entire transformation. Such a connection can facilitate the training of deeper networks by promoting stable gradient flow. The result of this addition is a first intermediate feature map X′. This entire sequence of operations can be mathematically represented by the formula:

X′=X+MHSSM(LN(X)).

The intermediate feature map X′ then serves as the input to the second component of the MambaFormer block MN. In step S340, X′ is again passed through a Layer Normalization (LayerNorm) operation to prepare it for the next stage. This process ensures that the input to the subsequent Channel MLP has a standardized distribution, which stabilizes training and can improve the model's performance.

The normalized output is then fed into step S350, a Channel Multilayer Perceptron (Channel MLP). The purpose of the Channel MLP is feature refinement. It operates on the features in a channel-wise manner, meaning it processes the feature vector at each spatial location independently to learn complex and adaptive interactions between channels.

Finally, in step S360, a second residual connection is performed. The output of the Channel MLP from step S350 is combined with the intermediate feature map X′ via an element-wise addition. This produces the final output feature map X″ of the MambaFormer block MN. This second sequence of operations is described by the formula:

X″=X′+Channel MLP(LN(X′)).

The MambaFormer block MN employs a dual-stage process. The first stage, utilizing the MHSSM, focuses on modeling spatial relationships across the feature map. The second stage, utilizing the Channel MLP, focuses on refining the features along the channel dimension. This two-pronged approach allows the architecture to effectively handle both spatial and channel-wise information, making it an efficient component for image restoration tasks.

FIG. 4 is a detailed block diagram illustrating the Multi-Head Selective Scan Module (MHSSM) S320, which was introduced as the token mixing component in the MambaFormer block of FIG. 3. This module is designed to efficiently capture long-range spatial dependencies in the input feature map. The input to the MHSSM module is the normalized feature map X produced by the LayerNorm block at step S310. The MHSSM S320 processes this input X through two parallel branches to generate an output feature map Xₒᵤₜ.

The first branch, the scanning branch 401, is responsible for performing the selective scan operation. The process in this branch begins at step S410, where the input feature map X is passed through a first linear layer. This linear layer transforms the input features, expanding the feature channels to facilitate more expressive representations. At step S420, the output of the linear layer is processed by a depth-wise 2D convolution (DWConv2D) layer. Unlike a standard convolution, a depth-wise convolution applies a separate filter to each input channel, which allows it to model spatial relationships within each channel independently and with significantly fewer parameters. Following the convolution, at step S430, the features are passed through a Sigmoid Linear Unit (SiLU) activation function. The SiLU function is a non-linear activation that helps the network learn complex patterns by introducing non-linearity into the model.

At step S440, the activated feature map, now denoted as MHSSᵢₙ, is fed into the Multi-Head Selective Scan (MHSS) operation. This operation is a component of the disclosure and is designed to efficiently model long-range dependencies across the spatial dimensions of the feature map. The MHSS operation partitions the feature channels into multiple groups, transforms each group into a one-dimensional sequence, performs a selective scan, and then transforms the results back into a two-dimensional format. This multi-head approach allows for parallel and efficient processing of spatial information. The detailed operational flow of the MHSS operation will be further described with reference to FIG. 5. The output of this step is denoted as MISSₒᵤₜ. At step S450, the feature map MHSSₒᵤₜ is processed by a Layer Normalization block to produce a normalized output feature map Y. This normalization step ensures that the output of the scanning branch 401 has a stable distribution before it is merged with the other branch.

The second branch, the gating branch 402, operates in parallel to the scanning branch 401 and serves to generate a gating feature map. At step S460, the same input feature map X is processed by a second linear layer to expand its channel dimension. Subsequently, at step S470, the output is passed through a Sigmoid Linear Unit (SiLU) activation function, generating a gating feature map Z.

At step S480, the feature maps outputted from the two branches are merged. The normalized feature map Y from the scanning branch 401 and the gating feature map Z from the gating branch 402 are combined through an element-wise multiplication. This gating mechanism allows the network to selectively emphasize or de-emphasize features produced by the scanning branch 401 on a per-pixel, per-channel basis, adding a layer of dynamic control.

Finally, at step S490, the merged feature map is passed through a final linear layer. This layer performs a final linear transformation that reduces the channel dimension of the merged feature map. This operation produces the final output feature map Xₒᵤₜ of the MHSSM module S320, ensuring that its dimensions are compatible with the input X for the subsequent residual addition at step S330 (as shown in FIG. 3).

The entire operational flow of the MHSSM S320 can be formally expressed by the following set of equations:

Y=LN(MHSS(SiLU(DWConv2D(Linear(X))))),

Z=SiLU(Linear(X)),

Xₒᵤₜ=Linear(Y⊗Z),
where the first equation defines the generation of the normalized output feature map Y from the scanning branch 401, encapsulating the operations from step S410 to S450. The second equation defines the generation of the gating feature map Z from the gating branch 402, corresponding to steps S460 and S470. The third equation defines the generation of the final output feature map Xₒᵤₜ, where the symbol ⊗ represents the element-wise multiplication in step S480, followed by the operation of the final linear layer in step S490.

FIG. 5 is a schematic diagram illustrating the operational flow of the Multi-Head Selective Scan (MHSS) operation S440, which is a component of the MHSSM module shown in FIG. 4. This process details how the apparatus 10 efficiently models long-range spatial dependencies. The input to this operation is the feature map MHSSᵢₙ, which is received from step S430, and its output is the feature map MISSₒᵤₜ, which is passed to step S450.

The operational flow begins at step S510 with a Channel Split operation. In this step, the input feature map MHSSᵢₙ, which has a plurality of channels, is partitioned into multiple groups 512 along the channel dimension. Specifically, if the input feature map MHSSᵢₙ has dimensions of H×W×C (Height×Width×Channels), and the apparatus 10 is configured to use n scanning patterns, the C channels are divided into n distinct groups. The parameter n is a positive integer greater than 1. Each resulting group 512 thus has dimensions of H×W×(C/n). This partitioning allows different subsets of features to be processed independently and in parallel. This approach of grouped feature processing is a feature of the multi-head design, enhancing the model's ability to capture diverse information without a linear increase in computational cost with the number of scanning patterns.

Next, for each of the plurality of groups 512, a Transform operation is performed at step S520. This step transforms each two-dimensional (2D) group 512 into a corresponding one-dimensional (1D) sequence, denoted as

$${SS}_{in}^{N}$$

(collectively, one-dimensional sequences 524). This transformation is based on a predetermined scanning pattern 522. The Transform operation is essentially a rearrangement that rearranges the feature vectors at each spatial coordinate of a 2D feature map into a 1D sequence. The order of this rearrangement is dictated by the specific scanning pattern 522. For example, a horizontal scanning pattern would traverse the 2D grid row by row, from left to right, appending each feature vector to the sequence. A vertical scan would proceed column by column. The diagonal and other complex patterns define more intricate traversal paths. Consequently, a 2D feature map of size H×W is converted into a 1D sequence of length L=H×W. As depicted, these patterns 522 can include, but are not limited to, a horizontal scanning strategy, a vertical scanning strategy, and various diagonal scanning strategies, along with their respective reversed orientations.

At step S530, a Selective Scan operation is performed on each of the one-dimensional sequences 524 (individually denoted as

$${SS}_{in}^{N} ) .$$

This operation applies a State Space Model (SSM) to efficiently model the long-range dependencies within each sequence. The operation is based on the principles of a discretized State Space Model, whose behavior at each position k in a sequence can be described by the following state update and output equations:

hₖ=Āhₖ₋₁+B̅xₖ

yₖ=Chₖ+Dxₖ

Here, xₖ represents the input vector at position k within a one-dimensional sequence 524. The corresponding output vector is yₖ, which collectively form a one-dimensional output sequence 532. The vector hₖ is the latent state at position k, serving as a memory that carries a compressed representation of the sequence's history up to that point, while hₖ₋₁ is the latent state from the previous position k−1.

The “selective” nature of the scan lies in the fact that the parameters B, C, and a parameter Δ are dynamically generated from the input sequence itself. The discretized matrices Ā and B̅ are then computed based on these input-derived parameters and a fixed underlying state matrix A. This dynamic generation allows the model to adaptively modulate the flow of information, selectively propagating or forgetting features based on the content of the input sequence xₖ. The D parameter represents a residual path from the input xₖ to the output yₖ, which in some implementations is handled by a residual connection outside the scan module. This step processes each 1D input sequence

$${SS}_{in}^{N}$$

to generate a corresponding one-dimensional output sequence

$${SS}_{out}^{N}$$

(collectively, one-dimensional output sequences 532), which encodes the contextual information captured along that specific scanning path.

Following the selective scan, at step S540, an Inverse Transform operation is performed on each one-dimensional output sequence 532 (individually denoted as

$${SS}_{in}^{N} ) .$$

This step to the reverse of the operation in S520, converting the 1D processed sequence back into its corresponding two-dimensional output group, thereby restoring the spatial structure of the feature map. Specifically, the Inverse Transform operation utilizes the same mapping defined by the corresponding predetermined scanning pattern 522 used in the forward transformation. Each element's position in the one-dimensional output sequence 532 corresponds to a unique spatial coordinate (e.g., a row and column index) in the two-dimensional grid. The operation systematically places each element from the sequence back into its original 2D location, effectively reconstructing the two-dimensional feature map grid. The resulting two-dimensional output group now contains features that have been contextually enriched with long-range dependency information captured along the specific directional path of its scan.

Finally, at step S550, a Channel Concatenation operation is performed. The two-dimensional output groups generated from the Inverse Transform step S540 are concatenated along the channel dimension. This step reassembles the individual processed groups into a single, cohesive feature map, which is the final output MHSSₒᵤₜ of the MHSS operation. Technically, this concatenation is the inverse operation of the initial Channel Split (S510). If the input feature map MHSSᵢₙ had C channels and was split into n groups, each two-dimensional output group would have C/n channels. The Channel Concatenation operation stacks these n groups along their channel axis, akin to placing blocks of features next to each other in the channel dimension. This results in a single feature map with dimensions identical to the input MHSSᵢₙ (e.g., H×W×C). The final output MHSSₒᵤₜ, which is denoted by reference numeral 542 in FIG. 5, thereby effectively combines the contextual information gathered from all the different scanning patterns into a unified feature representation.

In summary, the described apparatus and method introduce an efficient approach to image processing. The process involves partitioning an input feature map into a plurality of channel groups along the channel dimension. Each channel group is then processed independently by transforming its two-dimensional format into a one-dimensional sequence based on a predetermined scanning pattern, performing a selective scan operation to model long-range dependencies, and performing an inverse transformation to generate a two-dimensional output group. Finally, the processed two-dimensional output groups are concatenated to form the final output feature map. This architecture, particularly through the Multi-Head Selective Scan (MHSS) operation, enables the apparatus to effectively integrate information from multiple scanning patterns in parallel. This approach provides a comprehensive feature representation of the input feature map while maintaining computational efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for processing an image, comprising:
a memory storing instructions; and
a processing circuit communicatively coupled to the memory, wherein the processing circuit is configured to execute the instructions to perform operations comprising:
receiving an input feature map having a plurality of channels, wherein the input feature map is derived from the image;
generating a first feature map based on the input feature map;
partitioning the first feature map into a plurality of channel groups along a channel dimension;
for each of the plurality of channel groups:
transforming the channel group from a two-dimensional format into a one-dimensional sequence based on a predetermined scanning pattern;
performing a selective scan operation on the one-dimensional sequence to generate a corresponding one-dimensional output sequence; and
performing an inverse transformation on the one-dimensional output sequence to generate a corresponding two-dimensional output group;
concatenating the two-dimensional output groups corresponding to the plurality of channel groups along the channel dimension to form a second feature map; and
generating a final output feature map based on the second feature map.

2. The apparatus of claim 1, wherein the predetermined scanning pattern is selected from a group of scanning strategies consisting of: a horizontal scanning strategy, a vertical scanning strategy, a diagonal scanning strategy, a flipped diagonal scanning strategy, and respective reversed orientations thereof.

3. The apparatus of claim 1, wherein the plurality of channel groups comprises a first channel group and a second channel group, and wherein:
transforming the first channel group is based on a first predetermined scanning pattern; and
transforming the second channel group is based on a second predetermined scanning pattern, the second predetermined scanning pattern being different from the first predetermined scanning pattern.

4. The apparatus of claim 1, wherein the operations further comprise processing a first intermediate feature map with a channel multilayer perceptron (MLP), wherein the first intermediate feature map is generated based on a feature map derived from the second feature map.

5. The apparatus of claim 1, wherein the operations further comprise:
generating a gating feature map; and
generating a merged feature map by performing an element-wise multiplication between the gating feature map and a feature map derived from the concatenated two-dimensional output groups;
wherein generating the final output feature map is based on the merged feature map.

6. A method for processing an image, wherein the method is performed by a processing circuit executing instructions stored in a memory, the method comprising:
receiving, by the processing circuit, an input feature map having a plurality of channels, wherein the input feature map is derived from the image;
generating a first feature map based on the input feature map;
partitioning the first feature map into a plurality of channel groups along a channel dimension;
for each of the plurality of channel groups:
transforming the channel group from a two-dimensional format into a one-dimensional sequence based on a predetermined scanning pattern;
performing a selective scan operation on the one-dimensional sequence to generate a corresponding one-dimensional output sequence; and
performing an inverse transformation on the one-dimensional output sequence to generate a corresponding two-dimensional output group;
concatenating the two-dimensional output groups corresponding to the plurality of channel groups along the channel dimension to form a second feature map; and
generating a final output feature map based on the second feature map.

7. The method of claim 6, wherein the predetermined scanning pattern is selected from a group of scanning strategies consisting of:
a horizontal scanning strategy, a vertical scanning strategy, a diagonal scanning strategy, a flipped diagonal scanning strategy, and respective reversed orientations thereof.

8. The method of claim 6, wherein the plurality of channel groups comprises a first channel group and a second channel group, and wherein the step of transforming comprises:
transforming the first channel group based on a first predetermined scanning pattern; and
transforming the second channel group based on a second predetermined scanning pattern, the second predetermined scanning pattern being different from the first predetermined scanning pattern.

9. The method of claim 6, the method further comprising processing a first intermediate feature map with a channel multilayer perceptron (MLP), wherein the first intermediate feature map is generated based on a feature map derived from the second feature map.

10. The method of claim 6, wherein the method further comprises:
generating a gating feature map; and
generating a merged feature map by performing an element-wise multiplication between the gating feature map and a feature map derived from the concatenated two-dimensional output groups;
wherein generating the final output feature map is based on the merged feature map.
